(19) United States
(12) Patent Application Publication
(10) Pub. No.: US 2015/0098483 A1
(43) Pub. Date: Apr. 9, 2015

(54) DIODE-PUMPED NANO-STRUCTURE LASER

(71) Applicant: Lawrence Livermore National Security, LLC, Livermore, CA (US)

(72) Inventors: Raymond J. Beach, Livermore, CA (US); Mark D. Rotter, San Ramon, CA (US)

(73) Assignee: Lawrence Livermore National Security, LLC, Livermore, CA (US)

(21) Appl. No.: 14/045,614

(22) Filed: Oct. 3, 2013

(51) Int. Cl. H01S 3/16; H01S 3/091

(52) U.S. Cl. CPC H01S 3/169; H01S 3/091; Y10S 977/951; B82Y 20/00
USPC 372/66; 359/342; 977/951

(57) ABSTRACT

A solid state laser includes an optical resonator cavity and a containment vessel disposed in the optical resonator cavity. The solid state laser also includes a gas-flow system operable to pump solid state nano-structures through the containment vessel and one or more diode pumps optically coupled to the containment vessel.

### STATEMENT AS TO RIGHTS TO INVENTIONS MADE UNDER FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

Projections by the Energy Information Agency and current Intergovernmental Panel on Climate Change (IPCC) scenarios expect worldwide electric power demand to double from its current level of about 2 terawatts electrical power (TWe) to 4 TWe by 2030, and could reach 8-10 TWe by 2100. They also expect that for the next 30 to 50 years, the bulk of the demand of electricity production will be provided by fossil fuels, typically coal and natural gas. Coal supplies 41% of the world's electric energy today, and is expected to supply 45% by 2030. In addition, the most recent report from the IPCC has placed the likelihood that man-made sources of CO₂ emissions into the atmosphere are having a significant effect on the climate of planet earth at 90%. “Business as usual” baseline scenarios show that CO₂ emissions could be almost two and a half times the current level by 2050. More than ever before, new technologies and alternative sources of energy are essential to meet the increasing energy demand in both the developed and the developing worlds, while attempting to stabilize and reduce the concentration of CO₂ in the atmosphere and mitigate the concomitant climate change.

Nuclear energy, a non-carbon emitting energy source, has been a key component of the world's energy production since the 1950's, and currently accounts for about 16% of the world's electricity production, a fraction that could—in principle—be increased. Several factors, however, make its long-term sustainability difficult. These concerns include the risk of proliferation of nuclear materials and technologies resulting from the nuclear fuel cycle; the generation of long-lived radioactive nuclear waste requiring burial in deep geological repositories; the current reliance on the once through, open nuclear fuel cycle; and the availability of low cost, low carbon footprint uranium ore. In the United States alone, nuclear reactors have already generated more than 55,000 metric tons (MT) of spent nuclear fuel (SNF). In the near future, we will have enough spent nuclear fuel to fill the Yucca Mountain geological waste repository to its legislated limit of 70,000 MT.

Fusion is an attractive energy option for future power generation, with two main approaches to fusion power plants now being developed. In a first approach, Inertial Confinement Fusion (ICF) uses lasers, heavy ion beams, or pulsed power to rapidly compress capsules containing a mixture of deuterium (D) and tritium (T). As the capsule radius decreases and the DT gas density and temperature increase, DT fusion reactions are initiated in a small spot in the center of the compressed capsule. These DT fusion reactions generate both alpha particles and 14.1 MeV neutrons. A fusion burn front propagates from the spot, generating significant energy gain. A second approach, magnetic fusion energy (MFE) uses powerful magnetic fields to confine a DT plasma and to generate the conditions required to sustain a burning plasma and generate energy gain.

Important technology for ICF is being developed primarily at the National Ignition Facility (NIF) at Lawrence Livermore National Laboratory (LLNL), assignee of this invention, in Livermore, Calif. There, a laser-based ICF project designed to achieve thermonuclear fusion ignition and burn utilizes laser energies of 1 to 2 MJ. Fusion yields of the order of 10 to 20 MJ are expected. Fusion yields in excess of 200 MJ are expected to be required in a central hot spot fusion geometry if fusion technology, by itself, were to be used for cost effective power generation. Thus, significant technical challenges remain to achieve an economy powered by pure ICF energy.

In addition to ICF applications, there is broad interest in the area of high average power lasers for materials processing, drilling, cutting and welding, military applications, and the like. Frequency conversion of laser light can improve absorption coefficients in materials being processed or used in systems. Despite the progress made in high average power lasers and frequency conversion of output beams from such lasers, there is a need in the art for improved methods and systems related to lasers and frequency conversion.

### SUMMARY OF THE INVENTION

Embodiments of the present invention relate generally to optical systems. More particularly, embodiments of the present invention relate to methods and systems for diode-pumped solid state nano-structure lasers. In a particular embodiment, chemically inert, nanometer-sized particles entrained in a buffer gas are utilized for the gain medium of a laser or amplifier. The use of a buffer gas as the carrier for the nano-particles enables advective flow, which greatly increases the thermal management options available to the laser designer and enables power-scaling of the laser/amplifier system. The invention has applicability to a variety of solid-state laser gain media useful for a variety of applications. In contrast with solid state laser rods or slabs, which are heated volumetrically and result in thermal gradients between the center and edges of the active region, advective cooling is used as the lasant (the solid state nano-structures) is transferred out of the lasing cell before thermal gradients develop at a level that adversely impacts the laser performance. As described below, advective cooling of the laser can be achieved at modest flow rates in the range of 1-10 m/s.

Some embodiments relate to scalable diode-pumped laser systems using a static or flowing gas configuration in which nano-crystals or nano-particles, which serve as the lasant, are entrained in a buffer or carrier gas. Scaled power/energy laser systems are enabled by proper configuration of the density and size of the nano-crystals or nano-particles, resulting in laser/amplifier systems that can operate either continuous-wave, pulsed, or in an energy-storage configuration. The buffer gas serves the dual purpose of suspending/entraining the nano-crystals or nano-particles during the laser process, and also thermally coupling them. Because the nano-crystals or nano-particles are entrained in the buffer gas, flowing gas configurations are enabled which allow for the thermal control of the gain media via advective cooling. In comparison with some conventional techniques that utilize index-matching fluids to reduce scattering from the lasant, some embodiments of the present invention utilize the buffer gas to provide both suspension/motion of the lasant as well as thermal coupling. Thus, the lasers described herein reduce or eliminate issues presented by fluids, namely high values of dn/dT, which result in large changes in index of refraction for small temperature changes and corresponding large optical path differences.

According to an embodiment of the present invention, a solid state laser is provided. The solid state laser includes an optical resonator cavity and a containment vessel disposed in the optical resonator cavity. The solid state laser also includes a gas-flow system operable to pump solid state nano-structures through the containment vessel and one or more diode pumps optically coupled to the containment vessel.

According to another embodiment of the present invention, a method of operating an optical system is provided. The method includes proving a solid state laser medium and providing a containment vessel. The method also includes flowing the solid state laser medium through the containment vessel and optically pumping the solid state laser medium.

According to a specific embodiment of the present invention, an optical system is provided. The optical system includes a containment vessel operable to contain a plurality of solid state nano-structures and a pump system operable to inject and discharge the plurality of solid-state nano-structures from the containment vessel.

The laser/amplifier systems described herein are applicable to a wide variety of optical source applications, including, without limitation, energy/average-power-scaled laser gain sources for fusion drive lasers, lasers for defense applications, lasers for power-beaming applications, lasers for material processing and machining applications such as cutting, welding, peening, and surface treatment/modification, lasers for medical applications, lasers for short pulse applications, and lasers for scientific applications. In addition to these laser sources, amplifier sources can be utilized in one or more of the above-listed applications.

Numerous benefits are achieved by way of the present invention over conventional techniques. For example, embodiments of the present invention offer several advantages over conventional diode-pumped solid-sate and gas/vapor laser technologies. For instance, for crystalline-based-gain-media lasers, the size of the gain media is often restricted by crystal growth limitations. In the approach described herein, gain media of any size are possible by containing the buffer-gas-entrained nano-structure lasing medium in an appropriate vessel. This feature adds a new dimension to lasers requiring large crystalline slabs, such as fusion drive lasers. Also, average-power solid-state lasers are limited in their average power capability by the necessity of having to extract thermal power generated within the gain media through the gain media itself. This leads to temperature gradients that can generate optical aberrations that, in turn, deleteriously impact the beam quality generated by such systems. In extreme cases this thermal management constraint can stress the gain medium to breakage. In the approach described herein, thermal deposition within the gain medium is managed via flow of the gain medium. This effectively enables the thermal management of the gain medium to be carried on outside of the active lasing volume, offering increased flexibility to the average-power laser designer by separating the optical and thermal management components of the laser system. Additionally, because the lasing medium is essentially a gas, the lasing medium is impervious to optical damage.

Because the gain medium utilized in embodiments of the present invention includes chemically-inert nano-particles entrained in an inert buffer gas, such as He, embodiments of the present invention do not present issues that characterize lasing media having high chemical reactivity. Accordingly, many substantial system-level simplifications over conventional gas/vapor laser schemes are enabled by embodiments of the present invention. In particular, because of the increased thermal management freedom inherent in the designs described herein, significant improvements in beam quality are provided for scaled power/energy laser systems. Because the methods and techniques described herein are applicable to any diode-pumped solid-state laser gain material that can be fabricated in nano-crystal or nano-particle sizes, applications of the invention are broadly applicable throughout all of the laser application space. These and other embodiments of the invention along with many of its advantages and features are described in more detail in conjunction with the text below and attached figures.

### BRIEF DESCRIPTION OF THE DRAWINGS

FIG. 1 is a simplified schematic diagram illustrating a diode-pumped nano-particle laser according to an embodiment of the present invention.

FIG. 2 is a simplified schematic diagram illustrating a nano-particle laser using a split diode pumping architecture according to an embodiment of the present invention.

FIG. 3 is a transition diagram illustrating electronic transitions in a four-level system according to an embodiment of the present invention.

FIG. 4 is a plot showing Nd:YAG fluorescence lifetime vs. atomic percentage of Nd according to an embodiment of the present invention.

FIG. 5A is a contour plot showing optical-to-optical efficiency as a function of nano-crystal density and Nd concentration according to an embodiment of the present invention.

FIG. 5B is a contour plot showing optical-to-optical efficiency as a function of nano-crystal density and crystal diameter according to an embodiment of the present invention.

FIG. 6 is a plot showing optical-to-optical efficiency vs. output coupler reflectivity according to an embodiment of the present invention.

FIG. 7 is a bar chart illustrating pump flow-down according to an embodiment of the present invention.

FIG. 8 is a simplified schematic diagram illustrating a diode-pumped nano-particle amplifier according to an embodiment of the present invention.

FIG. 9 is a simplified flowchart illustrating a method of operating a diode-pumped nano-particle laser according to an embodiment of the present invention.

### DETAILED DESCRIPTION OF THE INVENTION

According to the present invention, techniques related to optical systems are provided. More particularly, embodiments of the present invention relate to methods and systems for diode-pumped, solid-state nano-particle lasers. In a particular embodiment, chemically inert, nanometer-sized particles entrained in a buffer gas are utilized for the gain medium of a laser or amplifier. The use of a buffer gas as the carrier for the nano-particles enables advective flow, which greatly increases the thermal management options available to the laser designer and enables power-scaling of the laser/amplifier system. The invention has applicability to a variety of solid-state laser gain media useful for a variety of applications.

Embodiments of the present invention provide diode-pumped laser and amplifier systems that overcome problems associated with conventional diode-pumped systems (such as the diode-pumped solid state laser (DPSSL) and the diode-pumped alkali laser (DPAL)). The inventors have determined that at least three major problems are associated with existing diode-pumped laser systems: (1) the restriction of gain media size due to crystal growth limitations, (2) the average power limitations in solid state lasers due to thermal management issues in the solid state laser medium, and (3) issues with some lasers that arise due to the highly reactive nature of their lasants.

Embodiments of the present invention circumvent challenging problems associated with emerging laser systems, such as the DPAL, in which the highly reactive nature of hot alkali vapors used for the lasing medium pose many challenging problems to the realization of practical laser systems. Because the nano-structures used in the systems described herein possess the same chemical inertness as their bulk counterparts, all the issues associated with high chemical reactivity can be avoided. Utilizing diode-pumped configurations, the systems described herein share many of the best attributes of DPSSLs and DPALs. Embodiments of the present invention provide a laser or amplifier architecture that provides high-average-power lasers with good beam quality, such as would be used in directed-energy applications and photon-assisted manufacturing applications; but also storage lasers such as those used as fusion drivers, and peak power lasers such as those used in laser peening. Embodiments of the present invention push the average power and beam quality capability of such systems in a very significant and application-expanding way.

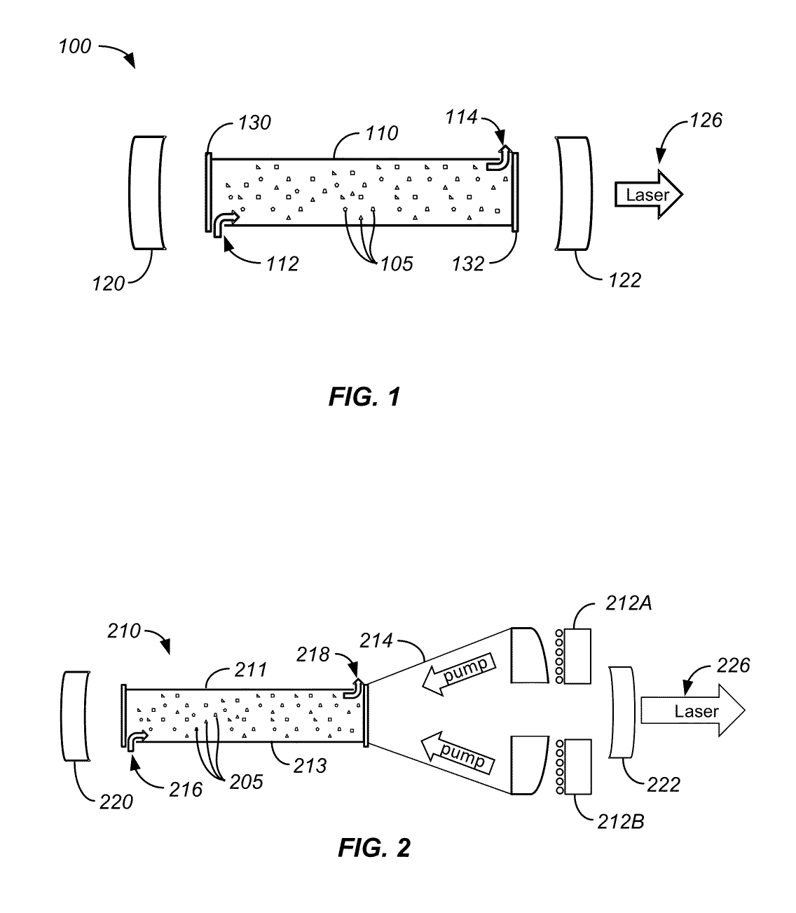

FIG. 1 is a simplified schematic diagram illustrating a diode-pumped nano-particle laser according to an embodiment of the present invention. In the embodiment illustrated in FIG. 1, the laser 100 includes a containment vessel 110 that holds a plurality of nano-structures 105 entrained in a buffer gas (not shown). The containment vessel 110 can also be referred to as a gas cell. In the embodiment illustrated in FIG. 1, the nano-structures 105 are a flowing stream of nano-structures entrained in the buffer gas, which can be referred to as a flowing gas configuration. As described more fully throughout the present specification, the nano-structures can be nano-crystals, nano-particles of solid state laser gain material, molecular structures, or the like. As a result, the use of nano-structures in a flowing gas stream enables power scalability that is not available using conventional laser and amplifier systems. The flow of the nano-particulates in FIG. 1 is longitudinal, i.e., the flow is substantially along the direction of propagation of laser light in the resonator formed by the high reflectance mirror 120 and the optical coupler 122.

The containment vessel 110, which also be referred to as a cell, is closed on each end with transparent windows 130 and 132. The active region, including the plurality of nano-structures 105 is optically enclosed in a resonator formed by high reflectance mirror 120 and output coupler 122, generating laser output 126 as shown. Referring to FIG. 1, in some implementations, the nano-structures 105 and entraining buffer gas enter the containment vessel through buffer gas/nano-structure inlet 112 and exit the containment vessel through buffer gas/nano-structure outlet 114. As a result, in the illustrated embodiment, the nano-structures are flowing from left to right, but this is not required by the present invention.

For purposes of clarity, the pump source and pump light delivery optics are not shown in FIG. 1. However, one of ordinary skill in the art will appreciate that the plurality of nano-structures 105 will be optically pumped by a suitable pump source. Accordingly, pump light can be delivered either transversely through the side walls of the containment vessel 110 or longitudinally through the resonator-end-optics (e.g., high reflectance mirror 120 and/or output coupler 132 and one or more of the transparent windows 130/132. In some embodiments, the pump light makes a first pass through the laser cavity, reflects off of high reflectance mirror 120 and then makes a second pass through the laser cavity in a double pass pump configuration. One of ordinary skill in the art would recognize many variations, modifications, and alternatives.

Thus, the laser cell can be configured to accept pump radiation through a window in the end of the cell, which can be referred to as an end-pumped configuration. In this configuration, the walls of the laser cell may be optically coated to reflect the pump light as it is ducted down along the length of the laser cell. Additionally, the optical coating on the cell walls may be configured to transmit amplified spontaneous emission (ASE) so as to frustrate parasitic lasing paths and/or excessive ASE losses.

In other embodiments, the laser cell is side-pumped and the laser cell has transparent side walls to permit the introduction of pump light into the cell, which may also be referred to as a transverse pump geometry. In this implementation, the flow direction of the nano-particles can be mutually perpendicular to laser beam propagation direction and pump beam propagation direction. In an embodiment, the flow direction is parallel to the beam propagation direction and orthogonal to the pump beam direction. It should be noted that although longitudinal flow of the nano-structures through the containment vessel is illustrated in FIG. 1, other embodiments utilize a transverse flow in which the nano-structures flow in a direction substantially orthogonal to the longitudinal axis of the resonant cavity or amplifier cavity.

Referring once again to FIG. 1, the ability to flow the nano-structure entraining buffer gas as shown in the figure enables thermal management of average-power laser systems through advective cooling. A variety of buffer gases can be utilized with embodiments of the present invention, including gases with desirable optical and thermal properties. As an example, helium, has a high thermal conductivity and a small Dale-Gladstone constant, making it suitable as a buffer gas. Other suitable buffer gases include H₂, N₂, O₂, F, Cl, Ne, Ar, Kr, Xe, ambient air, mixtures of the foregoing, and the like. The flow of the lasant through the laser cell can be performed at a sufficient rate to prevent thermal gradients above a predetermined threshold from building up to introduce an optical path difference (OPD) across the transverse aperture of the laser above a second predetermined threshold, thereby degrading beam quality.

In one implementation, the nano-particle laser illustrated in FIG. 1 can be operated in a manner that shares some operating principles with a heat-capacity laser. In this implementation, an isothermal slug of gain medium (i.e., nano-structures 105) is flowed into the containment vessel 110 and is heated up as it is pumped. Before beam-quality-impacting thermal gradients can establish themselves across the transverse aperture of the containment vessel (also referred to as a laser cell), the gain sample is flowed out of the cell and replenished with a new isothermal slug of gain medium. Inlet 112 and outlet 114 can be used to provide the source and sink for the slug of gain medium. Thermal management of the gain medium is then performed outside the active region after the gain medium is removed from the laser cell. With this configuration, thermal management is not complicated by the requirements that accompany the simultaneous optical and thermal management of the gain medium, which is characteristic of conventional average power DPSSLs.

Considering variations of the laser geometry illustrated in FIG. 1, rather than a rod-shaped gain sample, the containment vessel could have a rectangular shape, thereby providing a slab-shaped gain cell in which the same advective cooling techniques are also applicable. This cooling feature of the lasers provided by embodiments of the present invention can have a significant impact on the design of repetitively-pulsed fusion drive lasers that are currently limited in their repetition rate by thermal management issues since the heat generated within the slabs is removed via the slab faces. Thus, embodiments of the present invention can utilize large optical slabs configured so that they can be either pumped through their edges or faces and with provisions for flowing the buffer gas/nano-structure mixture through their volume.

Another variation is to have the cell windows (130 and 132 in FIG. 1) oriented at Brewster's angle relative to the beam-propagation direction. This configuration has the advantage of producing a linearly-polarized output beam while reducing or eliminating the need for anti-reflective coatings on the windows.

The inventors have studied the effects of particulate scattering on laser operation for the laser design illustrated in FIG. 1 and other embodiments described herein since low scattering losses correspond to efficiency in laser systems. Accordingly, a laser energetics model has been developed that includes the effects of nano-structures and the physics of scattering in such a gain medium.

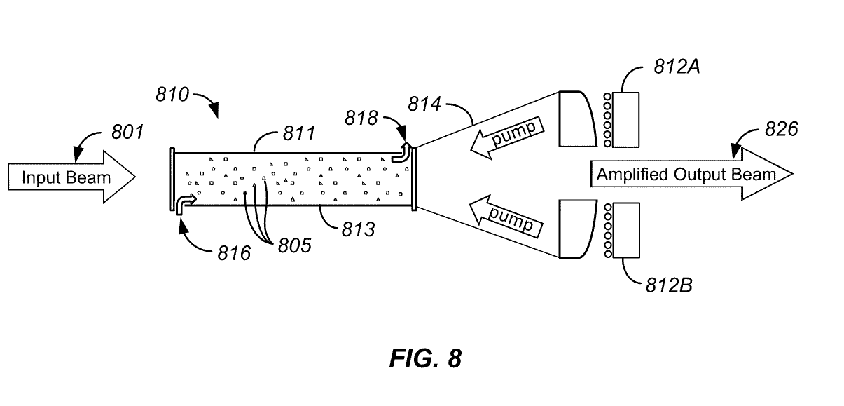

FIG. 8 is a simplified schematic diagram illustrating a diode-pumped nano-particle amplifier according to an embodiment of the present invention. In this configuration, which shares some system elements in common with the laser system illustrated in FIG. 1, one or more passes though the amplifier are utilized to amplify the input light and generate the output light. As illustrated in FIG. 8, input light in the form of an input beam 801 is received at the amplifier cell 810. Pump radiation from a split diode array 812A and 812B is delivered into the amplifier cell 810 via a lens duct 814. Once the pump light is in the amplifier cell 810, it is ducted along the length of the cell via reflective coatings placed on the inside surface of the cells lateral walls 811 and 813, which serve to reflect the incident pump light. As the pump light is ducted along the length of the cell, it is then absorbed by the nano-particles 805 that are entrained in the flowing buffer gas (not shown). Transparent windows 816 and 818 are utilized to define the ends of the amplifier cell 210. Amplified light is illustrated as amplified output beam 826.

In addition to discrete laser and amplifier configurations, a specific embodiment utilizes a first cell that is configured as a laser oscillator and one or more subsequent cells in the optics line that are configured as laser amplifiers. This configuration can be referred to as a master oscillator power amplifier (MOPA) configuration.

FIG. 2 is a simplified schematic diagram illustrating a nano-particle laser using a split diode pumping architecture according to an embodiment of the present invention. The system illustrated in FIG. 2 was utilized as an architecture for laser performance modeling described below. Pump radiation from a split diode array 212A and 212B is delivered into the end of laser cell 210 via a lens duct 214. Once the pump light is in the laser cell 210, it is ducted along the length of the cell via reflective coatings placed on the inside surface of the cells lateral walls 211 and 213, which serve to reflect the incident pump light. As the pump light is ducted along the length of the cell, it is then absorbed by the nano-particles 205 that are entrained in the flowing buffer gas (not shown). The laser resonator is formed by high reflectance mirror 220 and output coupler 222. Transparent windows 216 and 218 are utilized to define the ends of the laser cell 210.

The inventors have determined that several system metrics are associated with the nano-particle laser illustrated in FIG. 2. The scattering resulting from the nano-structures should be small enough to keep the total scattering losses below a predetermined threshold. The particulates should be present in the entraining buffer gas at a high enough density to substantially absorb the pump light in several passes through the laser cell. The pump irradiance level entering the end of the laser cell and rendering an efficient system should be reasonable. The inventors have determined that the pump irradiance utilized is available using conventional radiance-conditioned diode arrays. Additionally, the irradiance should be low enough to enable long-lived and reliable performance of the cell windows.

To assess the impact of scattering within a laser gain medium including nano-particles entrained in a buffer gas, it should be noted that the Rayleigh scattering limit applies. That is, the particle size (approximately 1-10 nm) is much less than the radiation wavelength (approximately 1,000 nm). In a particular embodiment, the nano-structures are ˜2-3 nm in size. In this regime, Mie theory reduces to the Rayleigh approximation. For such particles the total Rayleigh scattering cross section is given by,

$${σ}_{S} = \frac{2 {π}^{5}}{3} \frac{{d}^{6}}{{λ}^{4}} {( \frac{{n}^{2} - 1}{{n}^{2} + 2} )}^{2} \qquad ( 1 )$$

where d is the particle diameter, λ is the wavelength of the light being scattered, and n is the index of refraction of the particle doing the scattering. The inventors have determined that in comparison with conventional techniques, the use of nano-structures with dimensions in the range of several nanometers (e.g., less than 10 nm in diameter), reduce the Rayleigh scattering to levels that are acceptable for laser performance.

For specificity in the analysis that follows we will focus on a Nd:YAG based continuous-wave diode pumped nano-crystal laser (DPNCL) system. Although we focus on Nd:YAG for illustrative purposes, as a family of lasers the DPNCL is not limited to just Nd:YAG. There exist many rare-earth/crystal combinations that are appropriate for use in DPNCLs, and in fact there are even possibilities beyond crystalline-based gain media. For example, Nd:Glass, used in fusion drive lasers and industrial applications such as laser peening, is an appropriate gain medium, as are some chemical compounds such as Nd₂O₃. Each of the specific gain medium choices will be amenable to the same system optimization process that we have developed for Nd:YAG. Thus, in addition to Nd:YAG, nano-particle gain media can include Nd:YLF, Nd:GGG, Nd:GSGG, Nd:Y₂O₃, Nd:Y₂SiO₅, Nd:Glass, and the like. Moreover, the above crystals and glasses can be utilized with the rare earth neodymium replaced by one of the following: Pr, Pm, Sm, Tb, Dy, Ho, Er, Tm. Accordingly, a wide variety of solid-state laser media can be utilized with embodiments of the present invention. It should be noted that in some embodiments, the gain medium includes individual separated molecules of Nd₂O₃, or other molecules containing tri-valent rare-earth ions. Thus, the nano-particle may be provided in single molecule form. In some embodiments, a surfactant can be used to reduce the tendency of the molecules to agglomerate. Moreover, the present invention may utilize lasant particles that are quantum dots, i.e., semiconductors whose excitations are confined by the size of the semiconductor particle.

Moreover, although diode pumped configurations are described and modeled, the present invention is not limited to the user of diode laser pumps. The pump excitation source can be another laser, which is distinct from diode laser pumps, or, the pump excitation source can be a flash lamp. One of ordinary skill in the art would recognize many variations, modifications, and alternatives.

Although FIG. 1 and FIG. 2 illustrate nano-particles, also referred to as nano-structures, suspended or entrained in a buffer gas that flows through the laser cell, that is, the laser cell contains a flowing gas mixture which allows the buffer gas/nano-structure mixture in the cell to be periodically extracted and replaced with new buffer gas/nano-structure mixture, embodiments of the present invention are not limited to these particular implementations. In other embodiments, a static closed gas mixture is contained in the laser cell, with a system to keep the nano-crystals or nano-particles suspended throughout its volume.

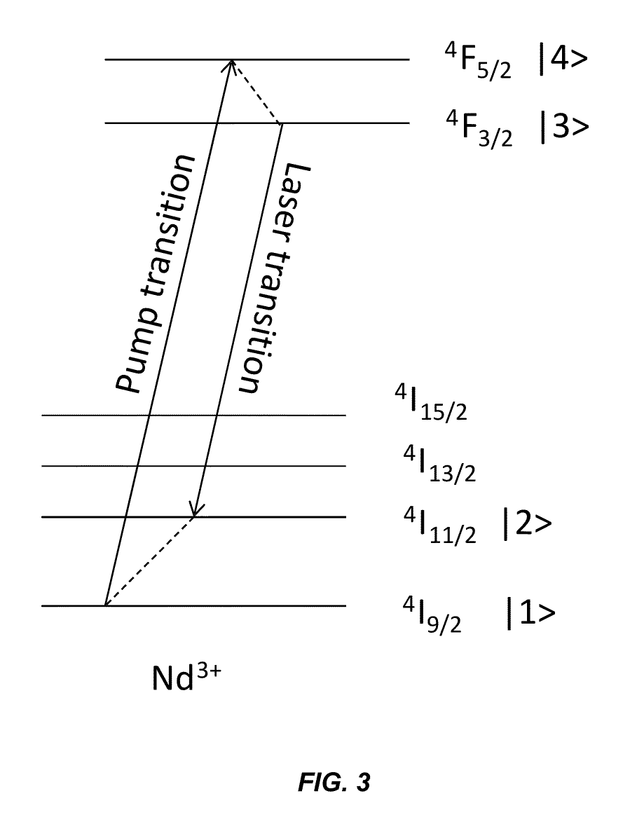

FIG. 3 depicts the Nd³⁺ levels involved in the Nd:YAG DPNCL system's lasing processes and illustrates the low-lying Nd³⁺ levels involved in the continuous-wave, 4-level Nd:YAG DPNCL discussed herein. The pump and laser transitions are depicted with solid lines while the phonon relaxation transitions that empty the ⁴F_{5/2} and ⁴I_{11/2} levels on a time scale that is rapid compared to other processes under consideration, are depicted with dashed lines. The grayed out ⁴I_{13/2} and ⁴I_{15/2} levels do not participate in the lasing process. For the purposes of the energetics modeling, the Nd³⁺ levels involved in the lasing process are labeled as 1, 2, 3 and 4 rather than using their more cumbersome spectroscopic notations. Embodiments of the present invention benefit from the fact that inner shell electron transitions in neodymium provide gain, whether in Nd₂O₃, disposed in a matrix site in a YAG crystal, or in an amorphous site in a glass. Thus, the electrons involved in the transition are shielded. As a result, the neodymium transition is somewhat insensitive to the particular environment, enabling the formation of lasants in nano-structure form.

In a particular embodiment, the laser cell includes nano-particles that are Nd:YAG and the pump excitation wavelength is near 808 nm, corresponding to the Nd^{3+ 4}I_{9/2}→⁴F_{5/2} transition. In another particular embodiment, the laser cell includes nano-particles that are Nd:YAG and the pump excitation wavelength is near 885 nm, corresponding to the Nd^{3+ 4}I_{9/2}→⁴F_{3/2} transition.

The populations in the various levels can be characterized by their longitudinally-averaged values:

$${n}_{i} = \frac{1}{{l}_{Cell}} {\int }_{{gain}_{sample}} d x {n}_{i} ( x ) for i = 1 , 2 , 3 , 4 \qquad ( 2 )$$

where l_{cell} is i the cell length and nᵢ is the population density of the i^{th} state. To simplify labeling, we will refer to the Nd³⁺ levels involved in the lasing process as 1, 2, 3 and 4 rather than using their more cumbersome spectroscopic identifications, as indicated in FIG. 3. Further, we will assume that the phonon-induced relaxations shown as dotted lines in FIG. 3 occur on a time scale that is rapid compared to other processes in the laser, an excellent approximation for the continuous-wave laser we consider here and one that immediately yields the simplifications,

n₂=0

n₄=0. (3)

Since n₁+n₂+n₃+n₄=n₀, where n₀ is the spatially-averaged Nd³⁺ density along the length of the gain sample in FIGS. 1 and 2, (3) immediately gives,

n₁+n₃=n₀. (4)

Because the size of the nano-crystals is much smaller than the wavelength of the pump and generated laser light, both the absorption and emission cross-section values must be modified from their bulk crystalline values when considering these processes in nano-crystalline samples. In the limit considered above (the Rayleigh scattering limit) in which the size of the nano-crystal is small compared to the wavelength of the pump or generated laser light, the absorption and emission cross-section values appropriate for the nano-crystalline media (or Mie values) are given by,

$${σ}_{Mie} = \frac{{π}^{2} {d}^{3}}{λ} Im ( \frac{{m}^{2} - 1}{{m}^{2} + 2} ) \qquad ( 5 )$$

where m is the complex refractive index of the particle, m=n+ik. The imaginary part of the refractive index k which represents gain or absorption in the nano-structures is given by,

$$k = \frac{λ {n}_{i} {σ}_{0}}{4 π} , \qquad ( 6 )$$

where σ₀ is the bulk crystalline material cross section value of the Nd³⁺ transition under consideration and nᵢ is the population of the i^{th} level. In the limit where the imaginary part of the refractive index is much less than the real part,

$${σ}_{Mie} = \frac{9 n}{{( 2 + {n}^{2} )}^{2}} \frac{4}{3} {π ( \frac{d}{2} )}^{3} {n}_{i} {σ}_{0} \qquad ( 7 )$$

which has the intuitively appealing interpretation of the cross section that would be expected in the nano-crystal (nano-crystal-volume x population-density x bulk-cross-section-value) modified by a factor that depends the refractive index n of the nano-crystal and represents the local field effect corrections seen by the ions in the nano-crystal. A convenient way to track the impact of the nano-crystal geometry on cross section values is to define effective cross-section values in terms of their bulk values by,

$${σ}_{eff} = \frac{9 n}{{( 2 + {n}^{2} )}^{2}} {σ}_{0} . \qquad ( 8 )$$

Using these effective cross-section values we can now write down an expression for the absorbed pump power,

$${P}_{P \text{-} ab s} = {P}_{P} {η}_{Del} ( 1 - {{e}^{- {n}_{1} \frac{9 n}{{( 2 + {n}^{2} )}^{2}} {σ}_{P} {l}_{Cell}}}^{- {n}_{1} \frac{9 n}{{( 2 + {n}^{2} )}^{2}} {σ}_{P} {l}_{Cell}} ) ( 1 + {R}_{P} {e}^{- {n}_{1} \frac{9 n}{( 2 + {n}^{2} )} {σ}_{P} {l}_{Cell}} ) \qquad ( 9 )$$

and a laser threshold equation,

$${e}^{2 ( \frac{9 n}{{( 2 + {n}^{2} )}^{2}} {σ}_{L} {n}_{3} - {σ}_{S} {n}_{NC} ) {l}_{Cell}} {T}_{W}^{4} {R}_{HR} {R}_{OC} = 1. \qquad ( 10 )$$

The parameters used in the Eqns. (9) and (10) that have not already been given are detailed in Table 1.

TABLE 1
Definitions of quantities used in modeling Eqns. (9) and (10)

| Quantity | Definition |
|---|---|
| P_{P-abs} | Usefully absorbed pump power in gain media (W) |
| P_{P} | Pump power generated at diode array (W) |
| η_{Del} | Delivery efficiency of pump power into the laser cell |
| n_{NC} | Density of nano-structures entrained in buffer gas (1/cm³) |
| σ_{P} | Pump absorption cross section assumed to be 5 × 10⁻²⁰ cm² for the 808 nm- |
| | pumped Nd: YAG case studied here |
| σ_{L} | Laser emission cross section assumed to be 2.8 × 10⁻¹⁹ cm² for the Nd: YAG |
| | case studied here |
| σ_{S} | Total Rayleigh scattering cross section given by equation (1) (cm²) |
| n | Refractive index of nano-particle material assumed to be 1.82 for the |
| | Nd: YAG case studied here |
| l_{Cell} | Length of the laser cell as shown in FIGS. 1 and 2 (cm) |
| R_{P} | Reflectivity with which the pump is reentrant into the laser cell after single |
| | passing the laser cell |
| T_{W} | Transmission efficiency of the intra-cavity generated laser light through the |
| | cell windows |
| R_{HR} | Reflectivity of the high reflectance mirror seen by the intra-cavity laser light |
| R_{OC} | Reflectivity of the output coupler seen by the intra-cavity laser light |

This formalism results in a system of 3 equations (Eqns. (4), (9), and (10)) that can be solved for the 3 unknowns: n₁, n₃, and P_{P-abs}, with all other parameters being defined by the laser configuration being studied.

An expression for the laser output power can be derived using the conservation of energy. To proceed, we write down expressions for the various output channels available to the absorbed pump power: the intracavity laser power scattered at the gain cell windows and resonator mirrors, the intracavity laser power scattered within the gain medium, the thermal power generated in the laser cell, and the fluorescence power that is radiated away by the laser cell. We then equate the sum of these output power channels to the absorbed pump power.

The intracavity laser power scattered at the laser cell windows and resonator mirrors is given by,

$${P}_{Window and mirror scatter} = {P}_{L} \frac{{R}_{OC}}{1 - {R}_{OC}} ( 1 - {T}_{W} ) + {P}_{L} \frac{{R}_{OC}}{1 - {R}_{OC}} {T}_{W} {e}^{( \frac{9 n}{{( 2 + {n}^{2} )}^{2}} {σ}_{L} {n}_{3} - {σ}_{S} {n}_{NC} ) {l}_{Cell}} ( 1 - {T}_{W} ) + {P}_{L} \frac{{R}_{OC}}{1 - {R}_{OC}} {T}_{W}^{2} {e}^{( \frac{9 n}{{( 2 + {n}^{2} )}^{2}} {σ}_{L} {n}_{3} - {σ}_{S} {n}_{NC} ) {l}_{Cell}} ( 1 - {R}_{HR} ) + {P}_{L} \frac{{R}_{OC}}{1 - {R}_{OC}} {T}_{W}^{2} {R}_{HR} {e}^{( \frac{9 n}{{( 2 + {n}^{2} )}^{2}} {σ}_{L} {n}_{3} - {σ}_{S} {n}_{NC} ) {l}_{Cell}} ( 1 - {T}_{W} ) + {P}_{L} \frac{{R}_{OC}}{1 - {R}_{OC}} {T}_{W}^{3} {R}_{HR} {e}^{2 ( \frac{9 n}{{( 2 + {n}^{2} )}^{2}} {σ}_{L} {n}_{3} - {σ}_{S} {n}_{NC} ) {l}_{Cell}} ( 1 - {T}_{W} ) + {P}_{L} \frac{{R}_{OC}}{1 - {R}_{OC}} {T}_{W}^{4} {R}_{HR} {e}^{2 ( \frac{9 n}{{( 2 + {n}^{2} )}^{2}} {σ}_{L} {n}_{3} - {σ}_{S} {n}_{NC} ) {l}_{Cell}} ( 1 - {R}_{OC} ) \qquad ( 11 )$$

where P_{L} is the laser output laser power. The last term in the sum in Eq. (11) is the intracavity laser power scattered at the output coupler, which is just the laser output power itself as can be seen by invoking Eq. (10). The intracavity laser light scattered by the gain media, the Rayleigh scattering already discussed, is given by,

$${P}_{Gain media scatter} = {P}_{L} \frac{{R}_{OC}}{1 - {R}_{OC}} {T}_{W} \frac{{σ}_{S} {n}_{NC}}{\frac{9 n}{{( 2 + {n}^{2} )}^{2}} {σ}_{L} {n}_{3} - {σ}_{S} {n}_{NC}} ( {e}^{( \frac{9 n}{{( 2 + {n}^{2} )}^{2}} {σ}_{L} {n}_{3} - {σ}_{S} {n}_{NC} ) {l}_{Cell}} - 1 ) + {P}_{L} \frac{{R}_{OC}}{1 - {R}_{OC}} {T}_{W}^{3} {R}_{HR} {e}^{( \frac{9 n}{{( 2 + {n}^{2} )}^{2}} {σ}_{L} {n}_{3} - {σ}_{S} {n}_{NC} ) {l}_{Cell}} \frac{{σ}_{S} {n}_{NC}}{\frac{9 n}{{( 2 + {n}^{2} )}^{2}} {σ}_{L} {n}_{3} - {σ}_{S} {n}_{NC}} ( {e}^{( \frac{9 n}{{( 2 + {n}^{2} )}^{2}} {σ}_{L} {n}_{3} - {σ}_{S} {n}_{NC} ) {l}_{Cell}} - 1 ) . \qquad ( 12 )$$

In calculating the thermal power generated in the laser cell and the fluorescence power radiated from the cell we will make the simplifying assumption that the branching ratio from the Nd^{3+ 4}F_{3/2} state to the ⁴I_{11/2} state is unity. Although this simplification could easily be removed and a more physically correct analysis given, the errors introduced with this approximation are small, and invoking this approximation keeps the expressions for thermal and fluorescence power much simpler and easy to manage. Under these simplifying conditions, the thermal power generated in the laser cell is given in terms of the absorbed pump power and the quantum defect of the pump-to-laser transition by,

$${P}_{Thermal} = {P}_{P \text{-} a bs} ( 1 - \frac{{λ}_{P}}{{λ}_{L}} ) \qquad ( 13 )$$

where λ_{P} and λ_{L} are the wavelengths of the pump and laser transition, respectively. For the study here, we will take λ_{P} to be 808 nm and λ_{L} to be 1064 nm.

The fluorescence power radiated from the laser cell is given by,

$${P}_{Fluorescence} = \frac{{n}_{3}}{τ} \frac{hc}{{λ}_{L}} {V}_{Cell} \qquad ( 14 )$$

where τ is the Nd³⁺ fluorescence lifetime and V_{Cell} is the volume of the laser cell containing the excited laser gain media. There are several complications associated with the value of the Nd³⁺ fluorescence lifetime τ appearing in (14) that are addressed to evaluate the performance of the DPNCL system using heavily-doped nano-crystals of Nd³⁺:YAG. Under conditions of heavy neodymium doping, cross-relaxation processes are known to shorten the fluorescence lifetime of Nd³⁺ ions in YAG. Although we don't need to consider the description of these cross-relaxation processes in detail here, we do invoke the experimentally measured fluorescence lifetimes to appropriately take this effect into account. There is also experimental evidence that Nd³⁺ ions that reside in the interior of nano-crystals experience a longer fluorescence lifetime, which depends on the size of the nano-crystal, than they would in bulk crystalline samples. This lifetime impact is due to the same local field corrections that impact the pump absorption and laser emission cross sections discussed previously. Finally, there is experimental evidence that ions sitting at or near the surface of the nano-crystals experience a faster decay than do ions sitting in the interior of the nano-crystal, probably because of quenching that occurs at or near the surface.

We model the fluorescence lifetime using the surface-impacted nano-crystalline value of 130 μsec unless the concentration-quenched value is less than this surface-impacted value, in which case we use the concentration-quenched value. Since shorter fluorescence lifetimes deleteriously impact the laser energetics performance, our assumptions amount to what is a worse-case scenario, i.e., laser performance is likely better than our model predicts under our present assumptions regarding fluorescent lifetime values.

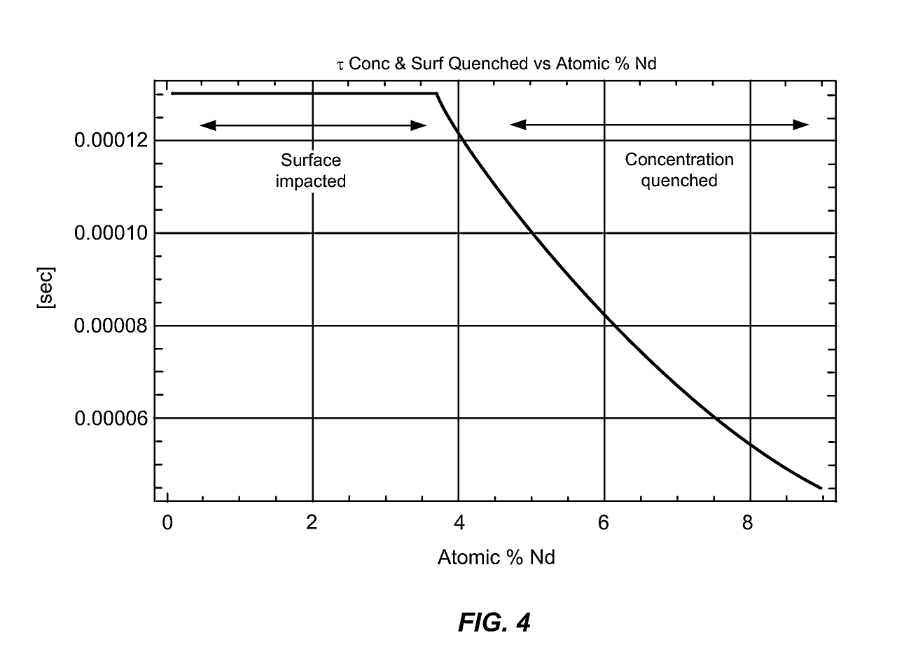

FIG. 4 is a plot showing Nd:YAG fluorescence lifetime vs. atomic percentage of neodymium according to an embodiment of the present invention. In particular, FIG. 4 shows a plot of the combined surface-impacted and concentration-quenched Nd³⁺:YAG fluorescence lifetimes as a function of the Nd³⁺ concentration in the YAG in terms of the atomic percent of neodymium in the crystal.

Using the previous expressions for power in the various pump power flow-down channels, we can find the output laser power, P_{L}, by simply solving the conservation of energy equation,

P_{Window and mirror scatter}+P_{Gain media scatter}+P_{Thermal}+P_{Fluorescence}=P_{P-abs}. (15)

To demonstrate that embodiments of the present invention provide highly efficient laser systems, the following case study is presented: the pump diode array power is assumed to be 20 kW, with a cell 20 cm long, and a cross sectional area of 0.5 cm². This area corresponds to either a circular-cross-sectioned cell having diameter of 0.8 cm or a square-cross-sectioned cell having side length of 0.7 cm. Table 2 summarizes the various parameters that describe the physical layout of the laser system and the pump.

TABLE 2
Parameters describing the physical layout
of the laser system and the pump

| Quantity | Description | Value | |
|---|---|---|---|
| P_{P} | Pump power generated at diode array | 20 | kW |
| η_{Del} | Delivery efficiency of pump power into the | 0.95 | |
| | laser cell | | |
| l_{Cell} | Length of the laser cell as shown in | 20 | cm |
| | FIGS. 1 and 2 | | |
| d_{Cell} | Cell diameter of circular-cross-sectioned | 0.8 | cm |
| T_{W} | Transmission efficiency of the intra-cavity | 0.996 | |
| | generated laser light through the cell windows | | |
| R_{HR} | Reflectivity of the high reflectance mirror seen | 0.996 | |
| | by the intra-cavity laser light | | |
| R_{OC} | Reflectivity of the output coupler seen by the | 0.7 | |
| | infra-cavity laser light | | |
| R_{P} | Reflectivity with which pump is reentrant into | 0.9 | |
| | the laser cell after its first pass through | | |
| η_{Mode} | Fraction of pumped volume usefully extracted | 0.95 | |
| | by laser | | |
| I_{P-cell} | Pump irradiance at cell input | 37.8 | kW/cm² |

The nominal values for the details of the nano-crystals: their size, their neodymium doping density, and their concentration in the buffer gas stream are listed in Table 3.

TABLE 3
Parameters describing the nano-crystals and their concentration

| Quantity | Description | Value | |
|---|---|---|---|
| At % Nd | Atomic percent of Nd in the nano-crystal | 4% | |
| τ | Value of Nd³⁺ fluorescence lifetime at the 4 | | |
| | at-% doping level in YAG | 122 | μsec |
| d_{Nano-crystal} | Diameter of nano-crystals | 2.3 | nm |

| | | |
|---|---|---|
| n_{NC} | Density of nano-crystals entrained in | 1.8 × 10¹⁸/cm³ |
| | buffer gas | |
| N_{Nd/nano-} | Average number of Nd³⁺ ions in each nano- | 3.5 |
| _{crystal} | crystal | |
| n₀ | Laser cell volume averaged Nd³⁺ ion density | 6.3 × 10¹⁸/cm³ |
| | (lasant density) | |

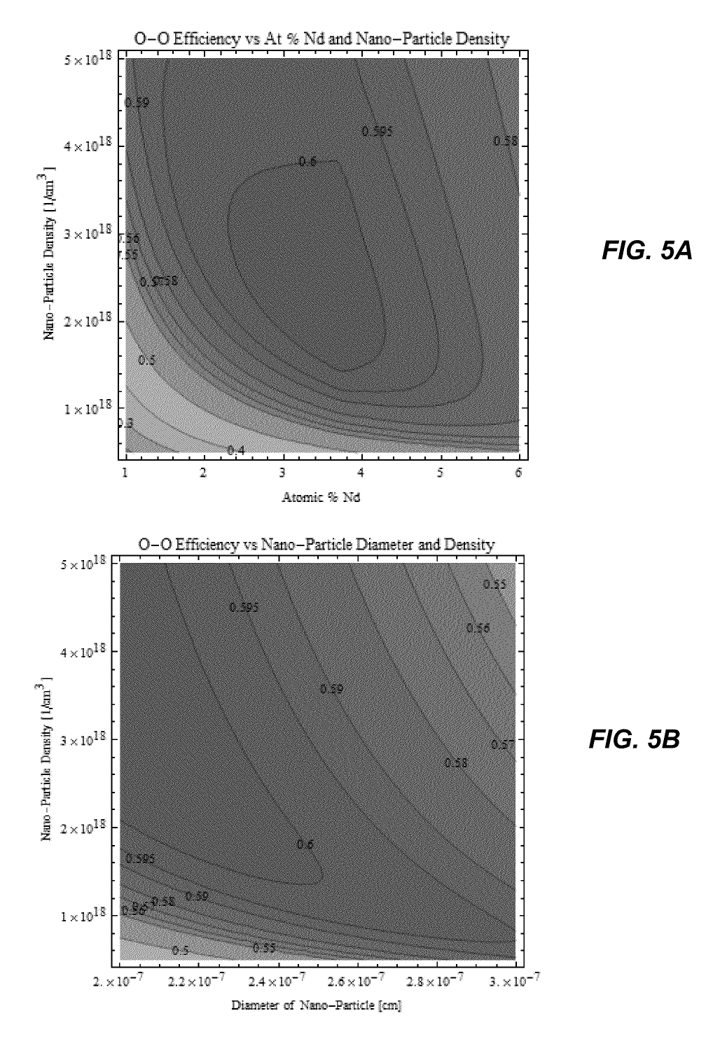

FIG. 5A is a contour plot showing optical-to-optical efficiency as a function of nano-crystal density and Nd concentration according to an embodiment of the present invention. FIG. 5B is a contour plot showing optical-to-optical efficiency as a function of nano-crystal density and crystal diameter according to an embodiment of the present invention. As shown in FIGS. 5A and 5B, the contour plots illustrate DPNCL system sensitivity to various parameter values associated with the nano-crystals listed in Table 3. As can be seen, the values used in Table 3 are the optimum for this particular system under study.

Referring to FIG. 5A, the contour plot shows the o-o efficiency of the DPNCL as a function of the nano-crystal density entrained in the buffer gas stream and the Nd³⁺ concentration in the nano-crystals. FIG. 5B shows the contour plot of o-o efficiency of the DPNCL system as a function of the nano-crystal density entrained in the buffer gas stream and the diameter of the Nd:YAG nano-crystals. Parameters not varied in these plots are as listed in Table 3.

In optimizing the performance of the DPNCL system, one implementation keeps the diameter of the nano-crystals as small as possible to minimize Rayleigh scattering, which varies as the 6^{th} power of the nano-crystal size (cf. Eq. (1)). But the size of the nano-crystals cannot be made so small that there are substantial numbers of nano-crystals that contain no Nd at all. For the presently considered 2.3 nm diameter nano-crystals, there are on average 3.5 Nd atoms per nano-crystal. The nano-crystal implementations of the present invention thus utilize nano-Nd crystals, which optically looks like a low density solid state medium. For particles on the size of several nanometers (e.g., 2-3 nm) in a vacuum environment, the low density particles will behave as an ideal gas in which the particles, rather than moving on the order of 1,000 m/s (characteristic of helium), would be moving on the order of several m/s.

Another interesting metric is the desire to keep the Nd concentration in the crystals high so as to minimize the gas stream density of nano-crystals required and so minimize Rayleigh scattering, against the desire to keep the Nd doping density in the nano-crystals low to avoid concentration quenching. Shorter storage lifetimes drive up the saturation intensity of the Nd³⁺ ions which negatively impacts overall system efficiency.

The DPNCL system described by the parameter values in Tables 1 through 3 also exhibits the important characteristic of very high small-signal gain. As a result, small values of output coupler reflectivity characteristic of unstable resonators can be supported.

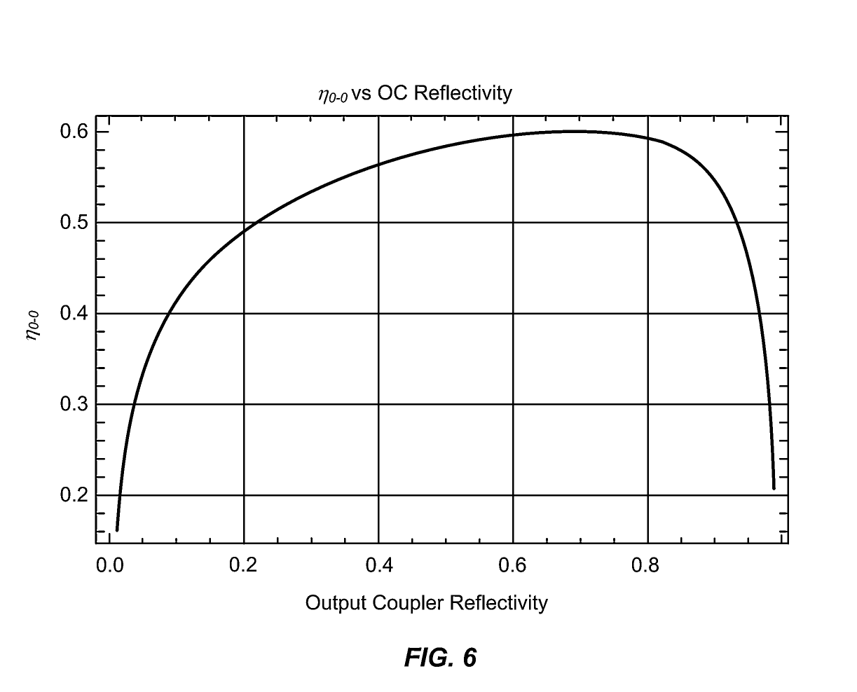

FIG. 6 is a plot showing optical-to-optical efficiency vs. output coupler reflectivity according to an embodiment of the present invention. As illustrated in FIG. 6, even at off-optimum output coupler reflectivities as low as 0.25, the o-o efficiency of the system is still seen to be above 0.5. The high gain and high efficiency demonstrated here is a critical component for enabling rugged compact systems capable of generating high output power with high beam quality using simple and efficient high-magnification unstable resonators.

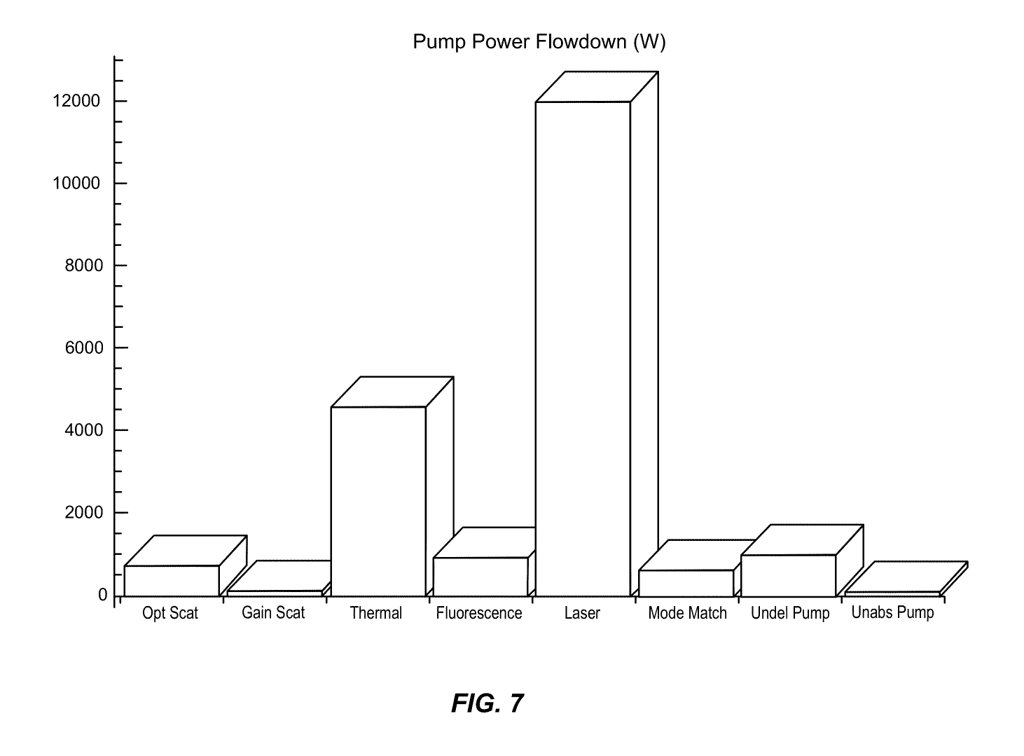

FIG. 7 is a bar chart illustrating pump flow-down according to an embodiment of the present invention and illustrates the powers in the various output channels available to the absorbed pump power in the DPNCL system. Of particular note is that the system output power optimizes at an o-o efficiency higher than 0.6 in a laser architecture that is scalable to arbitrarily large output powers by just scaling the system's output aperture. These efficiencies are very competitive with those possible using other laser systems.

In the embodiment associated with FIG. 7, various output channels are shown in (W) for the absorbed pump power assuming a 20 kW diode pump array that is delivered with an efficiency of 0.95 into the laser cell depicted in FIG. 2. The resulting output laser power is 12.03 kW. Of particular note is the large fraction of the pump that goes into thermal power, a result of Nd:YAG's large quantum defect of 0.24 for 808 nm pumping. This thermal power could be reduced by going to a design that directly pumps the Nd^{3+ 4}F_{3/2} level. In FIG. 7, ‘Opt scat’ is the scattering in the cell windows and at the resonator high reflectance mirror, ‘Gain scat’ is the Rayleigh scattering that takes place in the gain medium, ‘Thermal’ is the quantum defect generated thermal power, ‘Fluorescence’ is the fluorescence power, ‘Mode match’ is the power loss due to less than perfect mode matching between the pump and the extracting laser beam, ‘Undel pump’ is the pump power that never makes it into the gain cell due to less than unity η_{Del}, and ‘Unab Pump’ is the pump power that enters the laser cell but then escapes before being absorbed.

The DPNCL system's ability to generate high small-signal gain means that simple and robust unstable resonators, along with commercially-available diode arrays, may be used. As a result, the DPNCL is easily scalable to high average powers. The chemical inertness of the nano-crystals, as compared to other laser gain media in flowing-gas laser systems, further accentuates the overall advantage of the DPNCL vis-a-vis other laser systems.

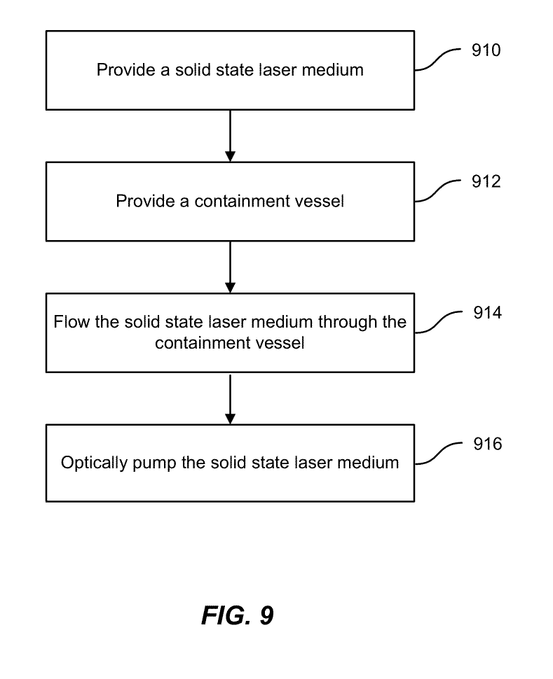

FIG. 9 is a simplified flowchart illustrating a method of operating an optical system (e.g., a diode-pumped nano-particle laser or amplifier) according to an embodiment of the present invention. The method includes proving a solid state laser medium (910) and providing a containment vessel (912). As an example, the solid state laser medium can be a rare earth element in crystalline or molecular form.

The method also includes flowing the solid state laser medium through the containment vessel (914) and optically pumping the solid state laser medium (916). The containment vessel can be characterized by a longitudinal direction and flowing the solid state laser medium comprises a longitudinal flow in some implementations. In a laser implementation, the method additionally includes generating laser radiation using an optical resonator enclosing the containment vessel. In an amplifier configuration, the method additionally includes injecting a seed signal into the containment vessel amplifying the seed signal in the solid state laser medium.

In an embodiment, the method also includes removing the solid state laser medium from the containment vessel to adjectivally cool the optical system. In some embodiments, flowing the solid state laser medium through the containment vessel comprises entraining the solid state laser medium in a buffer gas and flowing the buffer gas through the containment vessel. The buffer gas can be helium, other suitable gases, or combinations thereof. One of ordinary skill in the art would recognize many variations, modifications, and alternatives.

It should be appreciated that the specific steps illustrated in FIG. 9 provide a particular method of operating an optical system (e.g., a diode-pumped nano-particle laser or amplifier) according to an embodiment of the present invention. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A solid state laser comprising:
an optical resonator cavity;
a containment vessel disposed in the optical resonator cavity;
a gas-flow system operable to pump solid state nano-structures through the containment vessel;
one or more diode pumps optically coupled to the containment vessel.

2. The solid state laser of claim 1 wherein the gas-flow system is further operable to pump a buffer gas through the containment vessel.

3. The solid state laser of claim 2 wherein the buffer gas comprises at least one of He, N₂, or ambient air.

4. The solid state laser of claim 1 wherein the solid state nano-structures comprise at least one of nano-crystals or nano-particles.

5. The solid state laser of claim 4 wherein the nano-crystals comprise Nd:YAG.

6. The solid state laser of claim 4 wherein the nano-particles comprise Nd₂O₃.

7. The solid state laser of claim 4 wherein the solid state nano-structures are characterized by a diameter of less than 10 nm.

8. A method of operating an optical system, the method comprising:
proving a solid state laser medium;
providing a containment vessel;
flowing the solid state laser medium through the containment vessel; and
optically pumping the solid state laser medium.

9. The method of claim 8 wherein the solid state laser medium comprises a rare earth element in crystalline or molecular form.

10. The method of claim 8 further comprising removing the solid state laser medium from the containment vessel to adjectivally cool the optical system.

11. The method of claim 8 further comprising:
injecting a seed signal into the containment vessel; and
amplifying the seed signal in the solid state laser medium.

12. The method of claim 8 further comprising generating laser radiation using an optical resonator enclosing the containment vessel.

13. The method of claim 8 wherein the containment vessel is characterized by a longitudinal direction and flowing the solid state laser medium comprises a longitudinal flow.

14. The method of claim 8 wherein the containment vessel is characterized by a longitudinal direction, the solid state laser medium comprises a longitudinal flow, and the optical pump is introduced transverse to the longitudinal flow

15. The method of claim 8 wherein the containment vessel is characterized by a longitudinal direction, and the flow direction of the nano-particles can be mutually perpendicular to laser beam propagation direction and pump beam propagation direction.

16. The method of claim 8 wherein flowing the solid state laser medium through the containment vessel comprises:
entraining the solid state laser medium in a buffer gas; and
flowing the buffer gas through the containment vessel.

17. An optical system comprising:
a containment vessel operable to contain a plurality of solid state nano-structures; and
a pump system operable to inject and discharge the plurality of solid-state nano-structures from the containment vessel.

18. The optical system of claim 17 further comprising a resonant cavity enclosing the optical gain cell.

19. The optical system of claim 17 wherein the plurality of solid state nano-structures comprise nano-crystals including Nd.

20. The optical system of claim 19 wherein the nano-crystals including Nd comprise Nd:YAG nano-crystals less than 10 nm in diameter.

21. The optical system of claim 17 wherein the plurality of solid state nano-structures comprise nano-particles including Nd.

22. The optical system of claim 21 wherein the nano-particles including Nd comprise Nd₂O₃ particles less than 10 nm in diameter.

23. The optical system of claim 17 wherein the plurality of solid state nano-structures are entrained in a buffer gas.

24. The optical system of claim 17 further comprising a plurality of diode laser pump sources optically coupled to the containment vessel.
